(19) United States
(12) Patent Application Publication
(10) Pub. No.: US 2004/0251769 A1
(43) Pub. Date: Dec. 16, 2004

(54) Electric machine, especially a starter device

(76) Inventors: Ngoc-Thach Nguyen, Grossbottwar (DE); Quang-Ngoc Tran, Stuttgart (DE); Holger Roesner, Eilum (DE); Stefan Ossenkopp, Hildesheim (DE); Gerd Kirtsen, Kornwestheim (DE); Quoc-Dat Nguyen, Reutlingen (DE)

Correspondence Address: Striker Striker & Stenby, 103 East Neck Road, Huntington, NY, 11743, US

(21) Appl. No.: 10/491,090

(22) PCT Filed: Sep. 26, 2002
(86) PCT No.: PCT/DE02/03637

(30) Foreign Application Priority Data
Oct. 2, 2001 (DE) 101 48 669.3

(51) Int. Cl. F02N 1/00; B61C 9/38; B60L 11/02

(52) U.S. Cl. 310/261; 310/156.12; 290/22; 74/6

(57) ABSTRACT

An electrical machine, in particular a starter for motor vehicles, with a stator (36) and a rotor (39) is proposed; the rotor has a hollow shaft (63) with various shaft segments. The electrical machine is characterized in that the shaft (63), between a bearing seat (81) and a shaft segment contour (108) for transmitting a torque, is a one-piece tube.

### PRIOR ART

The invention relates to an electrical machine, in particular a starter, as generically defined by the preamble to the independent claim. From International Patent Disclosure WO 95/29529, an electrical machine in the form of a starter-generator is known, which has a hollow shaft with various shaft segments. The hollow shaft is embodied in multiple parts and comprises a first part with a bearing point onto which a seat for a magnetically operative rotor part is integrally formed. Inside the seat for the magnetically operative rotor part, there is a support tube that reinforces the shaft. In addition, two disks are placed inside the support tube and in turn reinforce the support tube or its action. The first shaft part with the seat for the magnetically operative rotor part is closed on one face end by a further shaft part and is braced in a bearing with the aid of this further shaft part. A pinion shaft part is inserted into the further shaft part and serves the purpose of starter-generator force transmission. In this embodiment, it is disadvantageous that producing the rotor of the electrical machine disclosed in this reference entails considerable effort and expense.

### ADVANTAGES OF THE INVENTION

The electrical machine of the invention having the characteristics of the main claim has the advantage that because the shaft is embodied as a one-piece tube, the production effort and expense are reduced considerably. Furthermore, the operation of assembly is reduced to a minimum. This tube is shaped to a defined contour either by so-called rotary swaging or by being widened radially outward. To that end, the interior of the tube is subjected to pressure, for instance hydraulically.

By the provisions recited in the dependent claims, advantageous refinements of the electrical machine defined by the main claim are possible.

It is especially favorable if the shaft includes a seat for a magnetically operative rotor part, because by that provision the electrically operative region of the shaft having the magnetically operative rotor part can be reduced to the minimum required. This reduces the load from the mass of the magnetically operative rotor part. Both friction and wear in the bearings are reduced. Moreover, the power loss is less, and the service life is lengthened. If the seat of the rotor part and an internal portion of the rotor part each have a contour that repeats on its circumference at regular intervals, then the two parts can be joined together by positive engagement. As a result, the torque transmission between the magnetically operative rotor part and the seat of the shaft is optimized. As a result, the pressure between the magnetically operative rotor part and the seat of the shaft can be reduced. As a result, the forces that occur upon joining the rotor part to the shaft are likewise less, thus markedly reducing the risk that the shaft will be warped during production.

If the seat of the shaft for the magnetically operative rotor part is guided by a stop on one side, then the axial position of the magnetically operative rotor part can be determined precisely during production.

If the shaft is embodied with a bearing seat for supporting the shaft on a first side of the seat for the magnetically operative rotor part, and the shaft is supported by a pinion on a second side, the result is an economical version of the support of the shaft. An equally economical alternative to the variant just described is attained by providing bearing seats on both the first side and the second side of the seat for the magnetically operative rotor part.

If both the first bearing seat and the second bearing seat are each supported in motor housing parts, then the motor of the electrical machine can be self-supported. This has the advantage that the motors can already be completely prefabricated and tested in advance for functional reliability.

If the shaft is embodied with an axial thrust face for at least one bearing element, an economical possibility of disposing the shaft in an axially defined way is attained.

Because the shaft includes a seat for a commutator electrically connected to the rotor winding, and this seat has a contour that repeats on its circumference at regular intervals, then if the commutator is embodied in that way as well, the commutator can be secured to the shaft by positive engagement. If the contours, for both the commutator and the magnetically operative rotor, that repeat at regular intervals are purposefully aligned with one another, then the commutator, with its laminations distributed over the circumference, can effectively be aligned electrically optimally with the rotor part.

If a transition between variously large outer diameters of adjacent shaft segments is embodied by a conical transition, then a rigid, lightweight transition is achieved. If the transition between two different-sized diameters of adjacent shaft segments is embodied as a disklike transition, then an especially short transition is achieved. Depending on what is required, it is also possible for both types of transition to be realized on one shaft.

If the shaft segment with which the torque of the motor is to be transmitted is embodied such that it has a contour, then an especially favorable shape for transmitting the torque is achieved.

### DRAWINGS

In the drawings, exemplary embodiments of an electrical machine of the invention, or its associated hollow shaft, are shown. Shown are:

FIG. 1, schematically, an electrical machine of the invention;

FIG. 2, the motor of the electrical machine of the invention;

FIG. 3A, a first exemplary embodiment of the hollow shaft;

FIG. 3B, the internal portion of the rotor part and FIG. 3C, the internal portion of the commutator;

FIGS. 4 and 5, a second exemplary embodiment of the hollow shaft;

FIGS. 6-9, longitudinal sections through various exemplary embodiments of the hollow shaft.

### DESCRIPTION

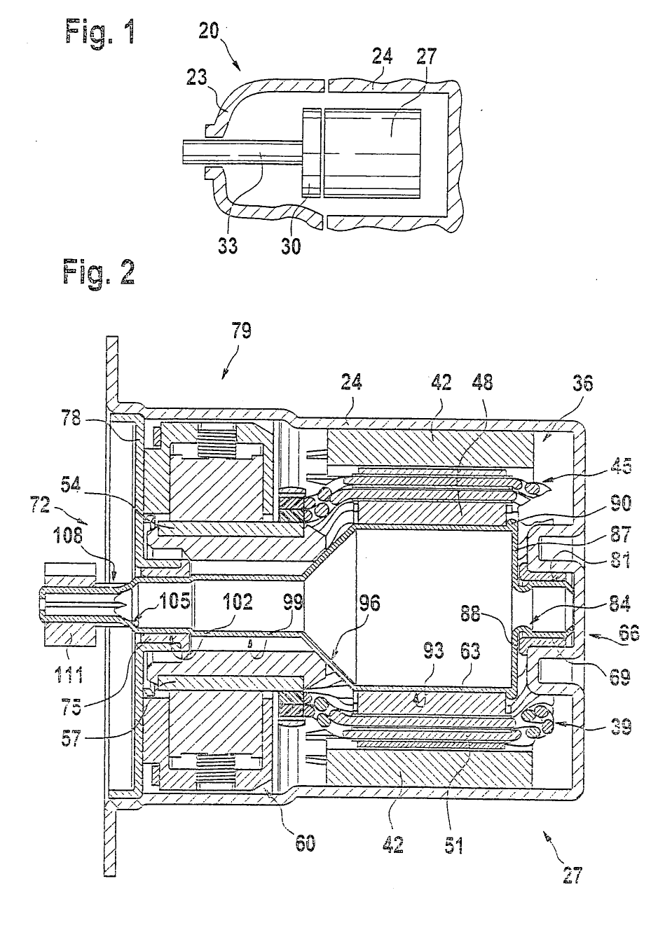

In FIG. 1, the electrical machine 20 of the invention is shown schematically. Inside a two-piece housing, which comprises the drive bearing housing 23 and the pole housing 24, there is an electric motor 27, which is followed by a planetary gear 30. A power takeoff shaft 33 following it is driven via the planetary gear 30.

In FIG. 2, a longitudinal section through the motor 27 is shown. A stator 36 and a rotor 39 are disposed inside the pole housing 24. The stator 36 comprises individual permanent magnets 42 disposed on an inside circumference of the pole housing 24. The rotor, with its magnetically operative rotor part 45, is disposed inside the stator 36. The magnetically operative rotor part 45 here comprises a lamination packet 48, which has a plurality of slots on its outer circumference. Electrical conductors 51 are inserted into these slots and can be supplied with current via a commutator 54. The commutator 54, on its circumference, has axially disposed laminations 57, which are connected on the one hand to the electrical conductors 51 and on the other can be connected at least indirectly, via a brush assembly 60, both to ground and to the positive pole of a starter battery. Both the magnetically operative rotor part 45 and the commutator 54 are firmly seated on a hollow shaft 63, which is supported on a first side 66 by means of a bearing element 69 in the pole housing 24. On the second side 72, the hollow shaft 63 is supported in a housing flange 78 by means of a further bearing element 75. The housing flange 78 is supported in a firmly seated manner in the pole housing 24.

The shaft 63 is hollow all the way through; it is a one-piece tube, and over its length it has various shaft segments. The shaft segments of the first variant of the hollow shaft 63 shown in FIG. 2 has the follow shaft segments, beginning at the first side 66:

The first segment is a bearing seat 81, which braces the hollow shaft 63 via the bearing element 69. Following this bearing seat is a transition 84 on the order of an undercut. This transition 84 serves to allow a grinding wheel, required for machining the bearing seat 81, to come freely to a stop. Furthermore, it serves to reduce the notch effect.

The undercut-like transition 84 is followed by a disklike transition 87, which at the same time serves as an axial thrust face 88 for the bearing element 69. The disklike transition 87 comes to an end radially outward with a stop 90. This stop 90 serves to limit the axial position of the magnetically operative rotor part 45 toward the first side 66. The stop 90 is followed by a seat 93 for the magnetically operative rotor part 45. The seat 93 is followed by a radially inward-extending conical transition 96, which ends in a seat 99 for the commutator 54. The seat 99 for the commutator 54 is followed by a bearing seat 102, around which the bearing element 75 is disposed. Above the bearing seat 102, the hollow shaft 63 is braced, as already noted, via the housing flange 78. The bearing seat 102 is followed by a further conical transition 105, which ends in a shaft segment contour 108. The shaft segment contour 108 serves to perform the transmission of a torque to a contour of a torque-transmitting part 111. The torque-transmitting part 111 in this case is a pinion, which acts as a sun wheel for the aforementioned planetary gear 30.

In the exemplary embodiment shown in FIG. 2, the motor 27 is embodied as self-supported. This means that the rotor 39 is supported completely via two bearing seats 81, 102 in the pole housing 24 and housing parts, such as the housing flange 78, respectively. No further bearing points for the rotor 39 are necessary. The housing flange 78 is part of a motor housing 79, which comprises the housing flange 78 and the pole housing 24. By means of the conical transition 96, a variously large outer diameter of adjacent shaft segments, such as the seat 93 for the rotor part 45, is graduated toward the seat 99 of the commutator 54. Also by the disklike transition 87.

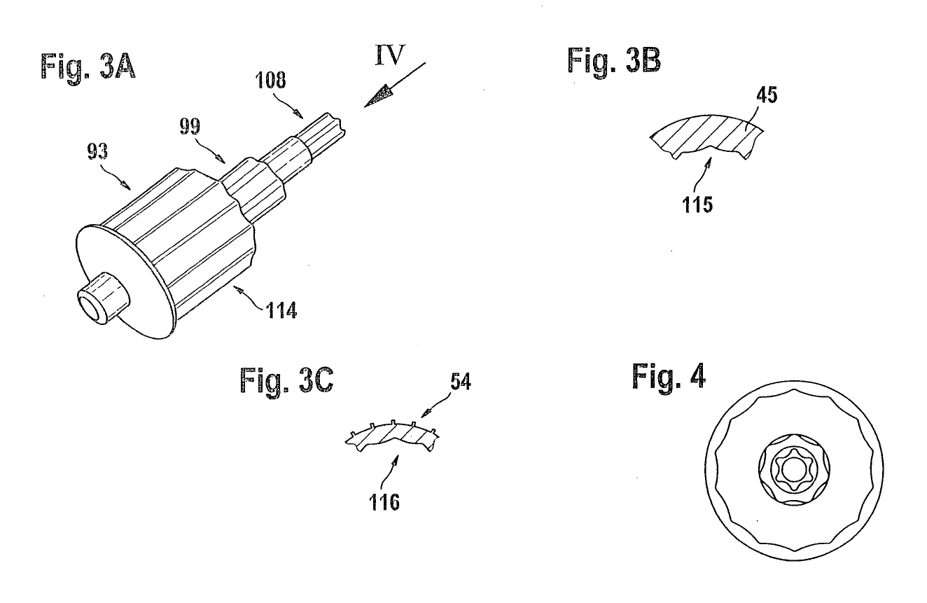

In FIG. 3A, the hollow shaft 63 is shown as a single part in a further exemplary embodiment. In a distinction from FIG. 2, the hollow shaft 63 has two further characteristics. The seat 93 for the magnetically operative rotor part 45 is embodied in profiled form here and has a contour 114 that repeats on its circumference at regular intervals; see FIG. 4 as well. In principle, this contour 114 comprises a multi-toothed profile, but contours that repeat in shaftlike fashion are alternatively suitable as well. In the exemplary embodiment, there are a total of fourteen individual contours or teeth or shafts at the seat 93. An internal portion 115 of the rotor part 45 has corresponding individual contours; see FIG. 3B. The seat 99 for the commutator, as FIG. 3A and FIG. 4 show, also has various individual, regularly spaced-apart, repeating contours, which correspond to contours of an internal portion 116; see FIG. 3C. While the seat 93 has fourteen connected contours, the seat 99 has half as many, or in other words seven contours. This makes it possible for a single lamination of the commutator 54 to be assigned to a single slot of the rotor part 45, keeping positional deviations between the commutator 54 and the rotor part 45 as slight as possible. The shaft segment contour 108 likewise has individual contours that repeat regularly, so the result is a regular polygon. This multi-toothed profile of the shaft segment contour 108 can on the one hand be used for slipping a torque-transmitting part 111 onto, or on the other, it can be used itself as a torque-transmitting part and for instance as a pinion.

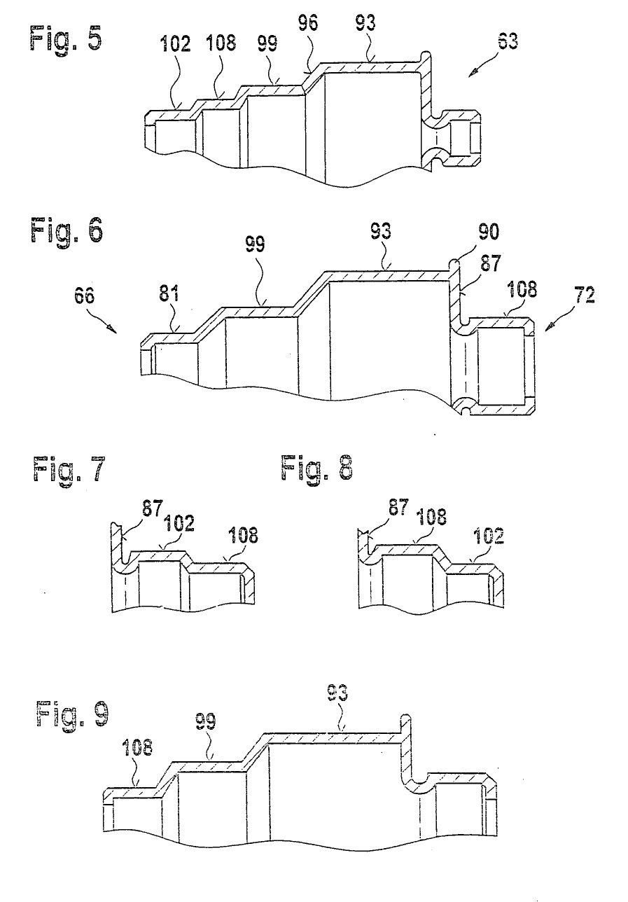

In FIG. 5, a cross section through the hollow shaft 63 in a further variant is shown. The essential distinction from what FIG. 2 shows is that the seat 99 for the commutator 54—except for the conical transitions—is followed first by the shaft segment contour 108 and only after that by the bearing seat 102. In this way, it is admittedly not possible to obtain a self-supported motor 27. Instead, in this variant, the bearing seat 102 is supported in the planetary gear 30, not in the ring gear carrier shown.

FIG. 6 shows a further variant of the hollow shaft 63. Here the first side 66 and second side 72 are transposed. While in this exemplary embodiment the hollow shaft 63 is supported via the bearing seat 81 in the pole housing 24 and the seat 99 for the commutator 54 then follows, that is in turn followed by the seat 93 for the rotor part, which is followed by the stop 90. Finally, the shaft segment contour 108 is disposed on the second side 72 of the hollow shaft 63. As in the previous exemplary embodiments, the torque-transmitting part 111 is slipped onto the shaft segment contour 108. A variant of the exemplary embodiment of FIG. 6 is shown in part in FIG. 7. Here, the bearing seat 102 is disposed between the disklike transition 87 and the shaft segment contour 108, so that once again, a self-supported motor 27 is achieved, as with the exemplary embodiment shown in FIG. 7 and FIG. 6. As an alternative to the exemplary embodiment of FIG. 7, it is possible, as in the exemplary embodiment shown in FIG. 8, to transpose the bearing seat 102 and the shaft segment contour 108.

In FIG. 9, based on the exemplary embodiment of FIG. 5, the bearing seat 102 can be omitted, so that the hollow shaft 63 is supported on the second side 72 in the planetary gear 30 by means of the shaft segment contour 108, or a torque-transmitting part 111.

1. An electrical machine, in particular a starter for motor vehicles, having a stator (36) and a rotor (39), the rotor having a hollow shaft (63) with various shaft segments, characterized in that the shaft (63), between a bearing seat (81) and a shaft segment contour (108) for transmitting a torque, is a one-piece tube.

2. The electrical machine of claim 1, characterized in that the shaft (63) includes a seat (93) for a magnetically operative rotor part (45).

3. The electrical machine of claim 2, characterized in that the seat (93) and an internal portion (115) of the rotor part (45) each have a contour that repeats on its circumference at regular intervals and as a result are joined together by positive engagement.

4. The electrical machine of claim 2, characterized in that the seat for the magnetically operative rotor part (45) has a stop (90) on one side.

5. The electrical machine of claim 1, characterized in that the shaft (63), on a first side of the seat (93), has a bearing seat (81) for supporting the shaft (63), and on a second side (72), the shaft (63) is supported by means of a torque-transmitting part (111).

6. The electrical machine of claim 1, characterized in that a first bearing seat (81) is disposed on a first side (66), and a second bearing seat (102) is disposed on a second side (72), of the seat (93) for the magnetically operative rotor part (45).

7. The electrical machine of claim 6, characterized in that the shaft (63) is self-supported in a motor housing (79) by means of both bearing seats (81, 102).

8. The electrical machine of claim 1, characterized in that the shaft (63) has an axial thrust face (88) for at least one bearing element (69).

9. The electrical machine of claim 1, characterized in that the shaft (63) includes a seat (99) for a commutator (54) that is electrically connected to the rotor winding, and the seat (99) for the commutator (54) and an internal portion (116) of the commutator (54) each have a contour that repeats on its circumference at regular intervals and as a result are joined together by positive engagement.

10. The electrical machine of claim 1, characterized in that variously large outer diameters of adjacent shaft segments are graduated by means of a conical transition (96).

11. The electrical machine of claim 1, characterized in that variously large outer diameters of adjacent shaft spacings are graduated by means of a disklike transition (87).

12. The electrical machine of claim 1, characterized in that one shaft segment has the shaft segment contour (108) that serves to transmit a torque to a contour of the torque-transmitting part (111).
